(19) United States
(12) Patent Application Publication
(10) Pub. No.: US 2005/0142940 A1
(43) Pub. Date: Jun. 30, 2005

(54) Quick-remove bar code scanner cable

(76) Inventor: Pierre-Marie Manine, Pibrac (FR)

Correspondence Address: ORUM & ROTH, 53 W. JACKSON BLVD, CHICAGO, IL, 60604, US

(21) Appl. No.: 10/954,856

(22) Filed: Sep. 30, 2004

Related U.S. Application Data
(60) Provisional application No. 60/507,421, filed on Sep. 30, 2003.

(51) Int. Cl. H01R 13/58

(52) U.S. Cl. 439/606

(57) ABSTRACT

The present invention is a rugged scanner cable connection. The board acts as a connector eliminating the need for a separate connector. One end of the cable board is soldered to the cable end. The board has connector pads at the other end. The cable board assembly is over molded with protective plastic to form a single rugged unit. The scanner end contains a simple receptacle for the board edge. The smart board in the cable allows multiple interfaces to be supported.

This application claims the benefit of U.S. Provisional Application 60507421 entitled Quick-Remove Bar Code Scanner Cable filed Sep. 30, 2003.

### BACKGROUND OF THE INVENTION

1. Field of the Invention

The present invention relates to bar code scanner cables. More particularly it relates to quick-remove bar code scanner cables with a low-cost, multi-interface, overmolded circuit board used as the connector.

2. Description of Related Art

Prior art scanners use a separate connector and board. There are two solder joints connecting the connecting cable to the scanner. One at the board and one at the connector.

There is a need for a rugged scanner cable connection that is low cost and easy to replace.

### SUMMARY OF THE INVENTION

The present invention is a rugged scanner cable connection. The board acts as a connector eliminating the need for a separate connector. One end of the cable board is soldered to the cable end. The board has connector pads at the other end. The cable board assembly is over molded with protective plastic to form a single rugged unit. The scanner end contains a simple receptacle for the board edge. The smart board in the cable allows multiple interfaces to be supported.

### BRIEF DESCRIPTION OF THE FIGURES

FIG. 1 is a first embodiment of the scanner connector.

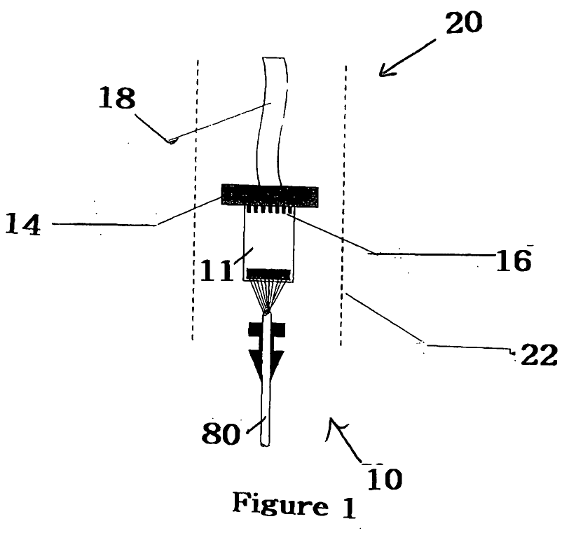

FIG. 2 is a second embodiment of the scanner connector.

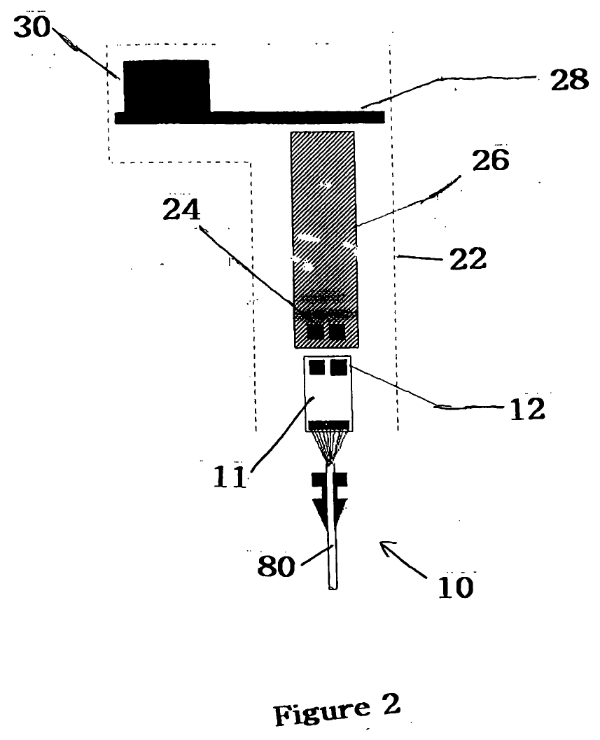

FIG. 3 is a third embodiment of the scanner connector.

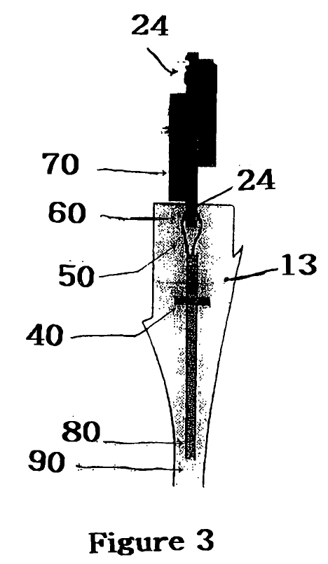

FIG. 4 is the exterior of an overmolded cable.

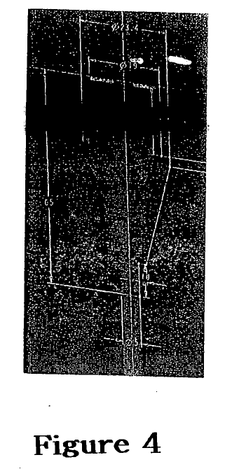

### DETAILED DESCRIPTION OF THE INVENTION

The present invention is a rugged scanner cable connection 10. The board 11 acts as a connector eliminating the need for a separate connector. One end of the cable board 11 is soldered to the cable 80 end. The board 80 has connector pads 12 at the other end.

The cable board 11 assembly is over molded with protective plastic 13 to form a single rugged unit. The scanner end contains a simple receptacle for the board edge. The smart board in the cable allows multiple interfaces to be supported.

The inventive connector eliminates two solder joints and a connector. One solder joint is eliminated at the board and one at the connector.

The board 11 of the inventive conductor functions as the connector. As a result, material and manufacturing costs are reduced and reliability is enhanced.

In one embodiment, the board has gold contacts 16 at one end. The other end is connected to the cable 80. The cable 80 can be connected to the scanner by contacting a card edge connector 14 to the gold contacts 16 on the board 11. Preferably, it connects to the scanner handle 22 the card edge connector is connected to the main board in the scanner with a flex connection 18.. The main board is operatively associated with the optical parts 30 of the scanner 20. The scanner 20 can have any shape such as a wand or gun.

In an alternative embodiment, the board 11 has contacts 12 at one end and the other end is connected to the cable 80. The cable 80 can be connected to the scanner by mating two banks of six contacts on a SIM or smart card 24 located on a connection board 26 of the scanner with the contacts 12 of the cable board 11. The connection board 26 is operatively associated with the main board 28 of the scanner 20. The main board 28 is operatively associated with the optical parts 30 of the scanner. The scanner can have any shape such as a wand or gun.

An alternative embodiment has a cable 80 that provides strain relief 90 to prevent damage to the cable.

The scanner has a SIM/smart card 24 with pads 60. A protection box 70 is associated with the SIM/smart card 24. The SIM/smart card 24 is connected at the pads 60 to wires 50 in the cable. The wires 50 are connected to the cable 80. Associated with the cable is a metal ring 40.

1. A scanner cable connection comprising:
a scanner cable,
a cable board soldered to a cable end,
said board having connectors adapted to quick connect to a scanner,
said board overmolded with a protective material.

2. The scanner cable of claim 1 wherein the connectors are gold contacts.

3. The scanner of claim 1 further comprising a card edge connector adapted to connect to a main board in a scanner.

4. The scanner of claim 2 further comprising a card edge connector adapted to connect to a main board in a scanner.

5. The scanner of claim 1 wherein the connection is a flex connection.

6. The scanner of claim 3 wherein the connection is a flex connection.

7. The scanner of claim 1 wherein the main board is operatively associated with the scanner.

8. The scanner of claim 3 wherein the main board is operatively associated with the scanner.

9. The scanner cable connection of claim 1 wherein the connector has a plurality of contacts.

10. The scanner cable of claim 9 wherein the connector has six contacts.

11. The scanner of claim 10 wherein the six contacts mate with contacts on a scanner board.

12. The scanner of claim 10 wherein the six contacts mate with six contacts on a scanner board.

13. The scanner of claim 10 wherein the six contacts of the connector mate with a smart card.

14. The scanner cable of claim 13 wherein the smart card is located on the scanner board.

15. The scanner cable of claim 14 wherein the scanner board is a connection board operatively associated with a main board of the scanner.

16. The scanner cable of claim 15 wherein the main board is operatively associated with optical parts of the scanner.

17. The scanner cable of claim 1 further comprising a metal ring.

18. The scanner cable of claim 1 further comprising a strain relief mechanism.

19. The scanner cable of claim 1 wherein the scanner connectors are pads.

20. The scanner of claim 19 wherein the pads are adapted to connect with a SIM or smart card in a scanner.
